(19) United States
(12) Patent Application Publication
(10) Pub. No.: US 2006/0010779 A1
(43) Pub. Date: Jan. 19, 2006

(54) Weatherstrip for a motor vehicle

(76) Inventors: Reimund Schlachter, Muehlacker (DE); Stephan Wetzel, Weissach (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/179,512

(22) Filed: Jul. 13, 2005

(30) Foreign Application Priority Data
Jul. 14, 2004 (DE) 102004033939.2

(51) Int. Cl. E06B 7/18

(52) U.S. Cl. 49/477.1

(57) ABSTRACT

A weatherstrip for use on a motor vehicle for sealing the space between a pivotable component, such as a door, and an adjoining fixed body structure is made of an elastic material and includes at least one longitudinally running tube profile. The form of the profile can be adjusted when the vehicle is in motion. To reduce the volume of pressurized fluid required for a good sealing function in this type of weatherstrip, the weatherstrip is designed to have only specific segments of the tube profile be inflatable when the vehicle is in motion.

This application claims the priority of German application 10 2004 033 939.2, filed Jul. 14, 2004, the disclosure of which is expressly incorporated by reference herein.

### BACKGROUND AND SUMMARY OF THE INVENTION

The present invention relates to a weatherstrip for a motor vehicle adapted to serve as a seal between a pivotable component, such as a door, and a fixed body structure, and which is composed of an elastic material and comprises at least one longitudinally running tube profile, the cross section of which can be controlled when the motor vehicle is operated.

In motor vehicles, and especially passenger cars, pivotable components such as doors, hatches or moon roofs lift away from the adjoining fixed body structure due to vacuums acting on the outsides of the vehicles when operating at high speeds. As a result, an interposed weatherstrip is no longer able to effectively seal the entire space between the pivotable component and the fixed component. Furthermore, such separation results in interfering drag, annoying wind noise, and water dripping into the passenger cabin.

Tests have shown that the pivotable components are effectively secured to body structures at their hinges and locks even when the motor vehicles are in motion. However, areas on pivotable structures located away from these points of attachment have tendencies to lift away due to aerodynamic forces present when the motor vehicle is in motion.

German document DE 1 430 936 C3 proposes a new type of weatherstrip for a car door in which a longitudinally running tube profile of the weatherstrip is realized as a pressure tight element throughout its entire length and is inflated via a pressure device when the car is operated. When the car is parked, a Vacuum is created in the tube. A disadvantage of this design is that, to inflate the tube profile, a considerable volume of pressure medium is required. If a liquid is used, a relatively high weight is incurred due to the high volume. If a portion of the hollow section is damaged, the sealing function is completely lost, therefore making it necessary to replace the part completely. Furthermore, inflation of the entire tube involves the unneeded inflation of sections that serve no functional purpose.

One object of this invention is to develop a weatherstrip of the type just described so as to allow a reduction in the volume of pressure medium needed for retaining a good sealing function.

According to the invention, this object can be achieved through permitting only segments of the tube profile of the weatherstrip to be inflated when the vehicle is operated. Further features of the invention are reflected in the claims.

Advantages achieved by the invention include a localized increase in sealing strength at the site where it is actually needed through the arrangement of inflatable sections of the seal. The energy output required for inflating the seal is reduced and significantly less pressure medium is needed by using such inflatable sections than if the entire tube were to be inflated. Because of filling elements present in the hollow space, which are pressurized hydraulically or pneumatically, the weatherstrip needs to be inflated only at areas where a sealing problem exists. The filling elements are connected via lines with a valve to a pressure source and control unit. Each filling element is made of a polymer, preferably an EPDM elastomer. Each filling element can also be reinforced at a defined site with a textile or film to ensure that each filling element can only expand to a set volume or shape. Compressed air or a liquid or can serve as the pressure medium. If an electrorheologic liquid is used as the pressure medium, the viscosity thereof can be changed by introducing additional electrical current to the liquid.

An embodiment of the invention is illustrated in the attached drawings, which are described in further detail below.

### BRIEF DESCRIPTION OF THE DRAWINGS

FIG. 1 is a partial Side view of a motor vehicle including a pivotable component and a fixed body structure,

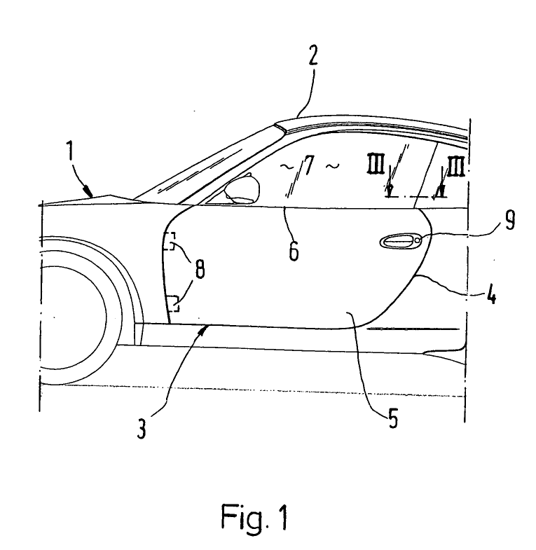

FIG. 2 is a side view of a weatherstrip adapted for interposition between the pivotable component and the fixed body structure according to the invention, and

FIG. 3 is a detailed sectional view of the weatherstrip and a portion of the component and the body structure adjacent thereto.

### DETAILED DESCRIPTION OF THE INVENTION

A motor vehicle 1 shown as a passenger car comprises a fixed body structure 2 with at least one pivotable component 3. A continuous weatherstrip 4 is interposed throughout the entire space running between the fixed body structure 2 and the pivotable component 3. In this embodiment, the pivotable component is a door 5, which has an adjustable-height frameless window pane 7 above the belt line 6. The leading edge of the door 5 is connected to the fixed body structure 2 via at least one hinge 8. The trailing edge of the door 5 is connected to the fixed body structure 2 via a lock 9.

The pivotable component can also be realized as a hatch, hood, or an adjustable sun or moon roof (not illustrated). The weatherstrip 4 made of an elastic material is attached to either the body structure 2 or the pivotable component 3 and comprises a relatively rigid mounting lip 10 as well as an elastic sealing section 11. The sealing section 11 has at least one longitudinally running tube profile 12, the cross section of which can be changed when the motor vehicle is operated. The weatherstrip 4 can also have multiple longitudinally running tube profiles 12.

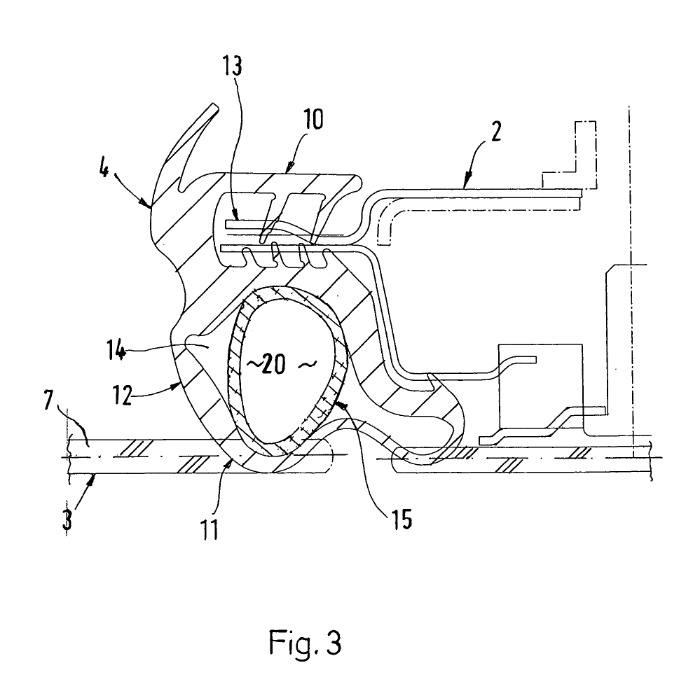

In the embodiment shown in FIG. 3, the weatherstrip 4 is attached to the fixed body structure 2. A U-shaped mounting lip 10 is adhesively secured to a raised flange 13 of the fixed body structure.

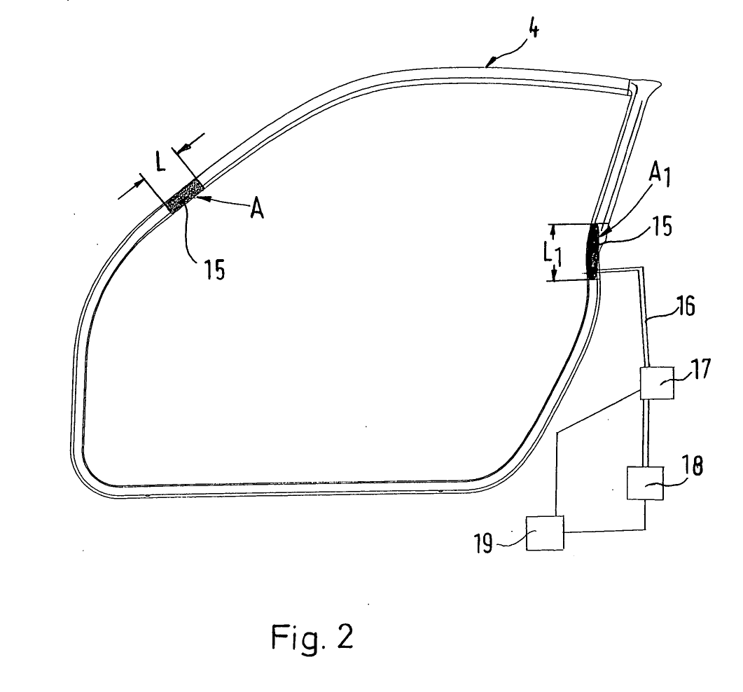

According to the invention, only sections A, A1 of the tube profile 12 of the weatherstrip 4 are inflated to a set volume. The inflatable sections A, A1 of the weatherstrip 4 are preferably situated at the sites where the pivotable component 3 has a tendency to lift away when the motor vehicle is operated or in areas where sealing is problematic, commonly referred to as incontinuities. FIG. 2 shows two inflatable section A, A1, which are present on different parts of the weatherstrip; section A is located at the junction of the mirror triangle of the door 5 and the adjoining door window pane 7, while section A1 is located at approximately the level of the belt line 6 where lower door body meets the door window pane 7. Although not illustrated as such in FIG. 2, the seal can be outfitted with additional sections.

In sections A, A1, hydraulically or pneumatically inflatable filling elements 15 are present in the hollow space 14 of the tube profile 12 and function to allow the form of the tube profile 12 to be precisely controlled. The filling element 15 present in section A has a length L. The filling element 15 present in section A1 has a length L1. The inflatable filling elements 15 are illustrated as being connected via lines 16 with a valve 17 to a pressure source 18 and a control unit 19 in such a way that, in this example, the set inflation and deflation of the tube profile 12 occurs in relation to vehicle velocity. The filling elements 15 are made of a polymer, preferably of EPDM elastomer. To ensure that the filling element 15 expands to a predetermined volume during inflation, the filling element is reinforced in at predetermined areas with a textile or film. A liquid or gas, e.g. compressed air, serves as the pressure medium 20. An electrorheologic liquid can also be used as a pressure medium 20, wherein the introduction of electric current to the fluid changes the viscosity thereof. The fundamental advantage of the arrangement described in the invention is as follows: Through the hydraulically or pneumatically inflatable filling elements, a localized increase in sealing force can be exerted on specific sections of the weatherstrip and can be adapted to driving conditions. The necessary sealing pressure is applied only where it is exactly needed. The sealing pressure .can be adjusted, e.g. increased during acceleration or minimized when the door is being closed. Because the pressure medium is directed only to specific sections, the weight and volume of the component can therefore be reduced. If the weatherstrip 4 is damaged, the likelihood of damage to the filling element 15 is low. Furthermore, the filling element 15 has its own wall, giving it greater resistance to damage and wear. As a result, both the frequency and cost of replacement parts remain low. A seal burst can be avoided, since the sealing force can be adapted to the assembly tolerance of the given motor vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A weatherstrip for a motor vehicle adapted to act as a seal between a pivotable component and an adjoining fixed body structure, the weatherstrip being made of an elastic material and comprising at least one longitudinally running tube profile with a cross section which can be changed when the vehicle is operated, wherein only segments of the tube profile of the weatherstrip can be inflated when the vehicle is operated.

2. The weatherstrip as claimed in claim 1, wherein, within the segments of the tube profile of the weatherstrip, hydraulically or pneumatically inflatable filling elements are situated in a hollow space of the tube profile, thereby enabling the cross section of the tube profile to be precisely changed.

3. The weatherstrip as claimed in claim 1, wherein the inflatable segments are present at sites on the weatherstrip where sealing is problematic.

4. The weatherstrip as claimed in claim 2, wherein the filling elements are connected via lines with a valve to a pressure source and a control mechanism.

5. The weatherstrip as claimed in claim 2, wherein each filling element is made of a polymer.

6. The weatherstrip profile as claimed in claim 2, wherein each filling element is reinforced with a textile or film at predetermined sites ensuring that the filling element expands to only a predetermined volume when inflated.

7. The weatherstrip as claimed in claim 1, wherein a liquid is used as a pressure medium.

8. The weatherstrip as claimed in claim 7, wherein an electrorheologic liquid is used as pressure medium so that introduction of electrical current to the liquid changes a viscosity thereof.

9. The weatherstrip as claimed in claim 1, wherein a gas is used as a pressure medium.

10. The weatherstrip as claimed in claim 5, wherein the polymer is an EPD elastomer.

11. The weatherstrip as claimed in claim 9, wherein the gas is compressed air.

12. The weatherstrip as claimed in claim 2, wherein the inflatable segments are present at sites on the weatherstrip where sealing is problematic.

13. The weatherstrip profile as claimed in claim 4, wherein each filling element is reinforced with a textile or film at predetermined sites ensuring that the filling element expands to only a predetermined volume when inflated.

14. The weatherstrip profile as claimed in claim 5, wherein each filling element is reinforced with a textile or film at predetermined sites ensuring that the filling element expands to only a predetermined volume when inflated.

15. The weatherstrip as claimed in claim 2, wherein a liquid is used as a pressure medium.

16. The weatherstrip as claimed in claim 16, wherein an electrorheologic liquid is used as pressure medium so that introduction of electrical current to the liquid changes a viscosity thereof.

17. The weatherstrip as claimed in claim 3, wherein a liquid is used as a pressure medium.

18. The weatherstrip as claimed in claim 18, wherein an electrorheologic liquid is used as pressure medium so that introduction of electrical current to the liquid changes a viscosity thereof.

19. The weatherstrip as claimed in claim 4, wherein a liquid is used as a pressure medium.

20. The weatherstrip as claimed in claim 19, wherein an electrorheologic liquid is used as pressure medium so that introduction of electrical current to the liquid changes a viscosity thereof.
